(19) United States
(12) Patent Application Publication
(10) Pub. No.: US 2008/0147818 A1
(43) Pub. Date: Jun. 19, 2008

(54) Email enhancement

(76) Inventor: Itzchak Sabo, Halamish (IL)

Correspondence Address: ROBERT G. LEV, 4766 MICHIGAN BLVD., YOUNGSTOWN, OH, 44505, US

(21) Appl. No.: 12/001,953

(22) Filed: Dec. 12, 2007

Related U.S. Application Data
(60) Provisional application No. 60/874,744, filed on Dec. 14, 2006.

(51) Int. Cl. G06F 15/16

(52) U.S. Cl. 709/206

(57) ABSTRACT

A method of improved handling of an email by a recipient email program comprising the steps of: (a) displaying a dialog to a sender of the email in response to the sender attempting to send the email to the recipient, wherein the dialog allows the sender to select tags for tagging the email, said tags being predetermined by the recipient; (b) sending the email together with tags selected by the sender from list of tags offered by the recipient, and (c) using the selected tags to prioritize the incoming email in accordance with recipient categories.

### FIELD OF THE INVENTION

The present invention is directed to providing email tools, methods and systems for aiding processing of email.

### BACKGROUND

As time passes, more and more people receive larger and larger volumes of email that require processing. By processing, any or all of a range of activities including reading, responding, deleting, ignoring, filing and similar actions are intended.

Processing emails takes time. People working at a computer may check their email many times a day, and often interrupt other tasks to do this.

Messages that are obviously urgent will typically be handled immediately, but other messages may be ignored, to be dealt with later. These will typically languish in the default folder for incoming emails—henceforth “inbox” waiting to be processed. Messages remaining unread in the inbox may be buried deep by later emails, and never read or acted upon.

A stressful feeling known as “email overload” may result from receiving more emails than can be processed, leading to the inbox becoming over full.

The commercially available email programs known to the present inventor typically display only the most basic information about an email, in particular, the name of the sender, the subject line and the date it was received. The default sorting practice of most email packages is to list the messages by date received, with the most recently received email messages being displayed first.

Most recently received rarely reflects the priority with which the different emails should be handled, but is symptomatic of the lack of ability of email programs to provide a better means of prioritization. It also satisfies the common urge for constant stimulation by something new.

Studies have shown that the most important factor used in deciding whether to read an email message is the identity of the sender. Indeed, it will be noted that email messages, as displayed in the in-box, usually display only two pieces of information useful for deciding whether to open and read the email now, to put off reading the email until later, or to ignore completely. These two pieces of information are the sender's details and the time it was received. The subject as defined in the subject line, the body, the importance ranking (high/medium/low) and other properties that may be ascribed by the sender are all subjective to the sender's viewpoint. The recipient's viewpoint may be somewhat different.

Indeed, because of the scant meta-data that is available for each message, it is often necessary to read a message in order to assess its importance. This is somewhat counter-productive, as an optimal notion of priority would dictate the order in which the messages should be read in the first place! One consequence of this is that many people make multiple passes through the contents of their inbox: first reading and prioritizing, and only then handling the messages in further passes. Others prefer to handle their email in a single pass. However, the problem with this approach is that important messages are not handled first, and due to the user's time constraints, time-sensitive messages may be handled late or even not at all. With both processing types, unimportant messages, including junk mail that is not filtered out automatically, serve as a distraction.

Another factor that contributes to inefficient inbox processing, and the inefficiency of email as a means of communication in general, is that many people do not express themselves well, particularly not in emails. It will be noted that emails are often written and sent out quickly. To the sender, they are informal and similar to telephone conversations. To the recipient, they are more similar to letters in that they seem more permanent and formal.

Since many people do not express clearly what they want from the recipient, time is wasted and misunderstandings are caused. The subject line is often not worded carefully, and the point of the communication, such as to pose a query or request, is often buried deeply in a rambling message. If the sender's desired outcome of an email is not clear, the recipient is inclined to miss the purpose of the communication. If the subject line is not crafted well, the message may not even be opened.

Some email programs allow users to define rules that process messages when they arrive, for example sorting messages into folders and color-coding them, based on testing for various user-defined conditions. Most users find these features too complicated and do not use them at all. Rules can work well for sorting messages by sender into specific folders and for identifying predictably formatted (often automatically generated) messages that trigger the recipient to perform routine tasks. However, the vast majority of messages are not predictably formatted and cannot be effectively prioritized by such rules. Rules, at the current stage of development, cannot truly understand the content of a message and cannot deduce the nature of the action that the sender is asking the recipient to perform, or even whether a message is actionable or not.

Borrowing from business facsimile and internal memorandum practices, and in attempting to reduce the burden of email, a number of large companies have adopted internal conventions such as where the sender pre-appends an agreed-upon acronym to the subject, to indicate how the sender expects the message to be handled. Examples of this are NRN—“no response necessary”, RR—“reply requested”, RAL—“read at leisure”. The problems with this approach include:

(1) The number of acronyms that can be learned by most email users is limited, as is the amount of meta-data of this type that can comfortably be inserted into a message.

(2) Conventions of this type cannot easily cross group/company boundaries and gain widespread acceptance.

Existing products and approaches to the above problems include SNARF and ClearContext. SNARF is a User Interface provided by Microsoft that is designed to provide a quick overview of unread mail, organized by its importance. The UI shows a series of different panes with unread mail in them; each pane shows a list of authors of messages. Clicking on a name shows all messages involving that person. People use a variety of strategies to handle triage; there is no single “best” ordering of email messages to produce an optimal outcome.

SNARF gives the user the freedom to build a personalized ordering. Each sender to a user's inbox is assigned a set of meta-information such as “number of emails sent in the last month,” for example. These metrics can, in turn, be combined to create an ordering across all contacts. ClearContext provides an Inbox Manager that is an email management solution for email users who want to manage their inbox more efficiently by monitoring previous emails from a sender and inferring importance from the way that the previous emails were responded to. It will be appreciated that such a system is only useful to the extent that the current urgency of a communication is analogous to the urgency of previous communications. The system is oblivious to the subject matter, and, if a sender has previously sent a message not requiring a response, such as daily jokes, for example, the sender may find an email message that is subsequently sent that does require a response not getting the attention it deserves.

Despite the available partial solutions as detailed hereinabove, there is a need for a more effective way of dealing with emails and the present invention addresses this need.

### SUMMARY OF THE INVENTION

It is an aim of the preferred embodiments of the invention to help users improve the efficiency of email as a business communications platform.

It is a specific aim to help email recipients prioritize incoming email according to their own true priorities.

It is a further specific aim to help senders express themselves more effectively when communicating via email.

In a first aspect, the present invention is directed to providing a method of improved handling of an email by a recipient email program comprising the steps of: (a) displaying a dialog to a sender of the email in response to the sender attempting to send the email to the recipient, wherein the dialog allows the sender to select tags for tagging the email, said tags being predetermined by the recipient; (b) sending the email together with tags selected by the sender from lists of tags offered by the recipient, and (c) using the selected tags to prioritize the incoming email in accordance with recipient preferences.

Preferably the tags comprise tags for identifying the relationship between sender and recipient.

Typically, the relationship being selected from the list of: boss, subordinate, colleague/peer, company employee, friend/family, customer, vendor/service provider, business contact and the like.

Typically, the tags comprise tags for identifying subject matter of email.

In one embodiment, predetermined tags of recipient are published on a server.

Typically the predetermined tags include a generic description of type of email selectable from a plurality of generic descriptions including at least some of: Action Request, Approval/Authorization Request, Quick question, Information, Scheduling/Meeting Agenda, Report/Summary, Idea/Proposal, Newsletter, Product/Service Offer, Reminder, Response to Information Request, Response to Action Request, Response to Approval/Authorization Request, Response to Quick question, Response to Information, Response to Scheduling/Meeting Agenda, Response to Report/Summary, Response to Idea/Proposal, Response to Newsletter, Response to Product/Service Offer, Response to Reminder, Response and Other.

Optionally the tags are selectable from default lists provided with a program that incorporates the method of handling emails of the invention.

Alternatively the tags are recipient defined.

Optionally the recipient can offer a range of acceptable times for preferred response for the sender to tag the email so that the recipient is notified how urgent the response is to the sender.

The method may be applied for bypassing spam filters, wherein the email is a message or newsletter of interest to recipient and the tag is a spam filter bypass tag of the recipient and the method further comprises configuring spam filters to always allow messages tagged with the spam filter bypass tag to bypass spam filters and to reach an inbox of the recipient's email program.

Optionally the spam filter bypass tag is a dedicated tag provided by the recipient to a specific sender only and configured to allow messages that carry the tag to reach the inbox of the recipient without being stopped by a spam filter, but only if they originate from the specific sender.

Optionally and preferably, an email sent to a plurality of recipients in a recipient list will be tagged by the sender system individually for each recipient in accordance with said recipient specific. These tags may be obtainable from a server, or from previous correspondence, for example.

In a second aspect, the present invention is directed to a software package for installing on an email terminal comprising tools for enabling a user to define and publish user profiles for displaying to an email sender.

Preferably the software package comprises prioritization rules for selection by the user to aid processing of incoming emails.

Preferably, the software package enables prompting the user to select relevant tags from user profiles published by the intended recipient when sending an email to the intended recipient.

Optionally, the software package enables color coding incoming messages and displaying incoming messages in accordance with rules predefined by the recipient.

Optionally the user can select and offer potential senders a range of responses acceptable to the user.

Optionally a single message sent to multiple recipients may be tagged with different tags for each recipient.

Typically a main recipient of an email as identified by TO field will be flagged with different tags from additional recipients as identified by C.C. and B.C.C. boxes.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a schematic illustration of an email traveling from a sender to a recipient over the internet;

FIG. 2 is a series of three illustrations showing usage of user profiles accessible on a database via the internet, wherein

FIG. 2a is a schematic illustration of a recipient posting his user profile on a database on the internet;

FIG. 2b is a schematic illustration showing a sender retrieving the intended recipient's user profile from the database, and

FIG. 2c is a schematic illustration showing how an email tagged in accordance with the recipient's user profile may then be sent to recipient via the internet;

FIG. 3a is a schematic illustration showing a tagged user profile being sent directly from a recipient to a potential sender;

FIG. 3b is a schematic illustration showing an outgoing email from a sender to a recipient tagged with selected tag(s) from the tags of the recipient's user profile;

FIG. 4 is a schematic illustration showing how a recipient's user profile may be downloaded from a database on a central server by a sender, and then used to provide appropriate tag(s) for tagging outgoing emails;

FIG. 5 is a schematic illustration of a tagged message sent from sender to recipient;

FIG. 6 is a functional block diagram of the components of one embodiment of the present invention loaded onto sender and recipient's computer systems;

FIG. 7a is a flowchart showing the steps performed by a sender's implementation to tag an outgoing email with recipient's tags;

FIG. 7b is a flowchart of stages performed by recipient's email system implementing the present invention;

FIG. 8 is a screen capture of an email window showing a draft ougoing message;

FIG. 9 shows an example of a Dialog box as displayed to the sender in accordance with one implementation of the invention showing the main recipient's tags, and C.C.ed recipients;

FIG. 10 is a screen capture of an exemplary dialog box displaying rules to the recipient allowing him to prioritize incoming emails by rule and also to color code them in accordance with one implementation of the invention;

FIG. 11 is a screen capture of a dialog box for defining rules in accordance with one implementation of the invention, and

FIG. 12 is a screen capture of the list of emails in the inbox, sorted in accordance with priorities and also displaying message type as defined in categories selected or defined as tags by the recipient.

### DESCRIPTION OF THE PREFERRED EMBODIMENTS

The applicant has noted that triage on an incoming email message typically consists of two distinct analysis steps:

Categorization: What kind of message is it? Does it require a reply? Does it need to be acted upon? If so, what action is appropriate? By when?

Prioritization: Based on how it is categorized, how important is this message compared with other messages?

The prioritization step is dependent on the results of the categorization step.

Whereas in the prior art, messages are typically characterized and prioritized by the sender in accordance with sender considerations, in the present invention, the categorization step is separated from the prioritization step, and both steps are automated and optimized. It is a particular feature of the present invention that each step is performed by a different person, with the categorization step being performed by the sender and the prioritization step being performed by the recipient. This contrasts to standard prior art email programs such as Microsoft Outlook which allow the sender to label emails as low priority or high priority. In preferred embodiments, the categorization, though performed by the sender, is performed in accordance with the recipient's categories.

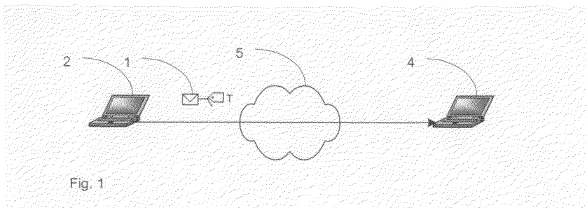

With reference to FIG. 1, in its most primitive, an email message 1 is sent by a sender 2 to a recipient 4 over the internet 5. The sender 2 may tag the message 1 using standard tags T that aid the recipient 4 to prioritize the email message 1. Tagging facilities may be built into commercially available and commonly used current email programs such as Microsoft Outlook for example. By virtue of being essentially a tagging or labelling software implementation for tagging or labelling emails, and prioritizing them based on these tags, this will henceforth be referred to as priority tagging or PrioriTags for short.

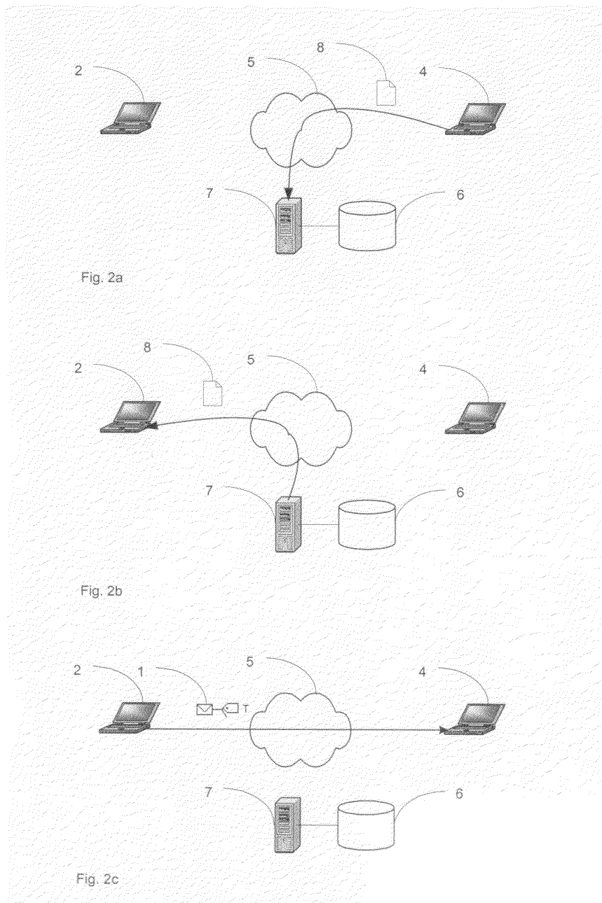

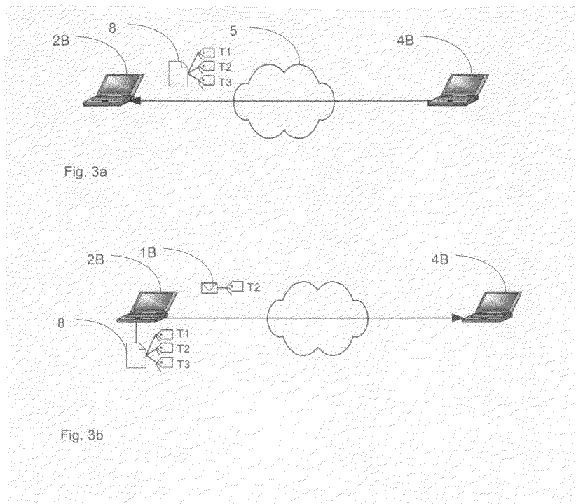

Reference is now made to FIGS. 2a, 2b and 2c, which, taken together, show how a user profile 8 containing lists of tags can be posted by a recipient 4 on a server 7, and accessed via the Internet 5 by a sender 2. Typically the system includes a Central Server 7, which is essentially a repository for all published user profiles. Referring specifically to FIG. 2a, when a potential recipient 4 is a user of the tagging system of one embodiment of the present invention, he may have previously uploaded his personally customized user profile 8 to the Central Server 7 over the Internet 5. The personally customized user profile 8 will typically be stored in a database 6 linked to the Server 7 and accessible thereby. With particular reference to FIG. 2b, Sender 2 may access and upload the recipent's user profile 8 from the user profile database 6. With specific reference to FIG. 2c, once the sender 2 has accessed the user profile 8 of the recipient 4 from the Central Server 7, the sender 2 may select tags T from recipient's 4 user profile 8 that are relevant to the message 1.

It will be appreciated that a user profile database 6 is not required in all scenarios however. With reference to FIG. 3a, if the recipient 4B and sender 2B have been in contact in the past, the recipient 4B may have previously provided sender 2B with his profile 8. In such a scenario, the sender 2B simply uses the recipient's 4B profile 8 as provided by the recipient 4B and can select an appropriate tag T2 from the range of tags T1, T2, T3 provided therewith to tag the outgoing email message 1B.

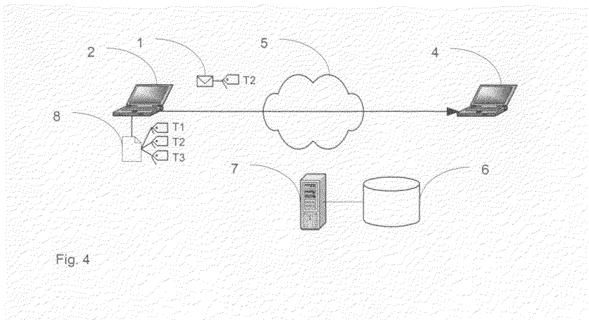

With reference to FIG. 4, once a sender 2 has a set of recipient customized tags, regardless of whether previously obtained from a user profile database 6 or previously provided by the recipient 4 in a previous email exchange, the sender 2 may send an email 1 to the recipient 4 via the Internet 5; the email 1 being characterized by being tagged with one or more tags T2 provided by the recipient 4.

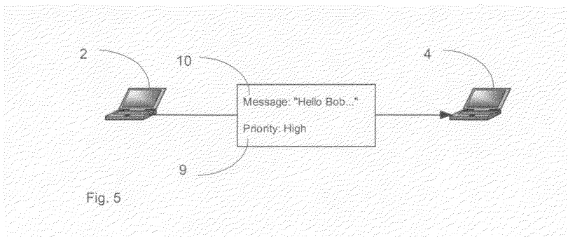

As shown in FIG. 5, in addition to the novel, recipient determined tagging that is a unique feature of the invention, the sender 2 may still tag a message 10 with a prior art sender defined tag 9 such as High Priority, as currently provided by standard email programs, such as Microsoft Outlook, for example.

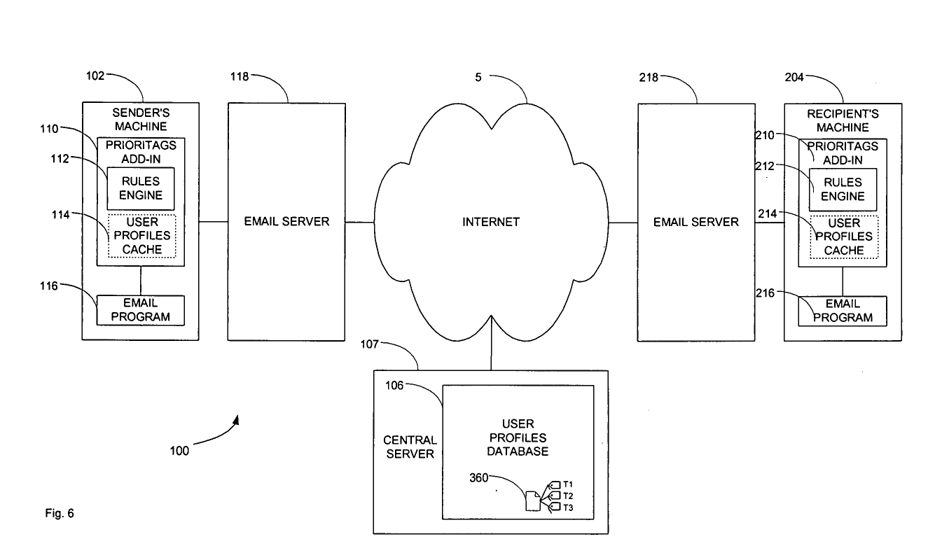

With reference now to FIG. 6, one embodiment of the invention is configured as a system 100 that consists of a sender's priority tag add-in 110 that includes a rules engine 112 and a user profiles cache 114. Sender's PrioriTags add-in 110 sits on the sender's machine 102 and retrofits to the sender's email program 116. The sender 2 accesses the Internet 5 through the sender's email server 118. The recipient 4 has a similar configuration consisting of a recipient's PrioriTags add-in 210 that includes a rules engine 212 and a user profiles cache 214. Recipient's PrioriTags add-in 210 sits on the recipient's machine 202 and retrofits to the recipient's email program 216 and accesses the Internet 5 through the recipient's email server 218.

Sender and recipient's PrioriTags add-ins 110, 210 are typically identical and a user's PrioriTags add-in may be used for sending and receiving, with a large number of users being PrioriTags enabled.

The system 100 also includes a central server 107 supporting a user profiles database 106 in which a plurality of profiles 360 each consisting of a number of tags are provided.

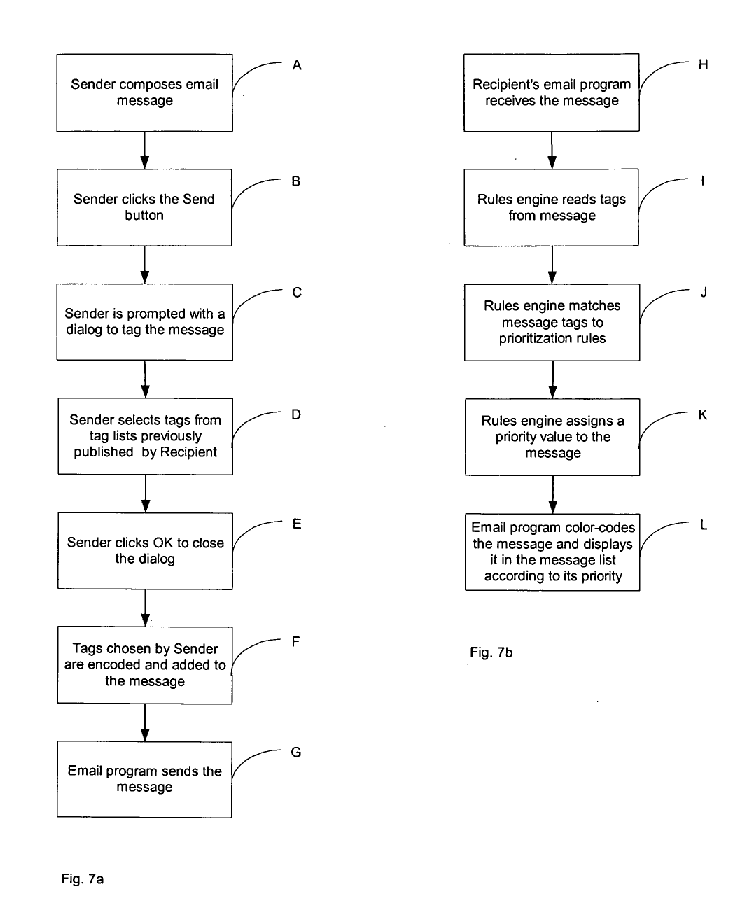

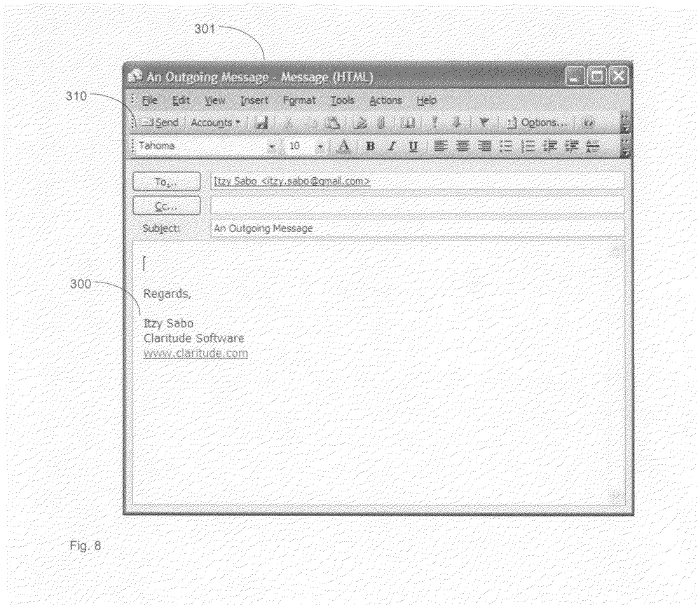

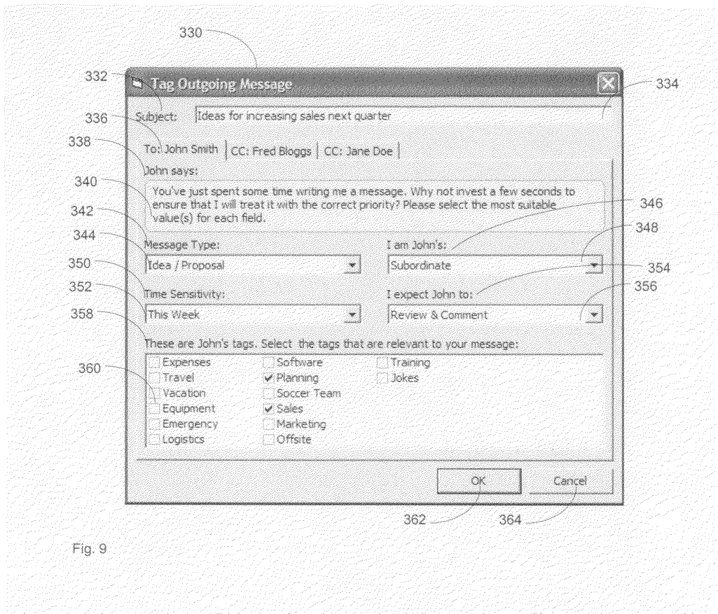

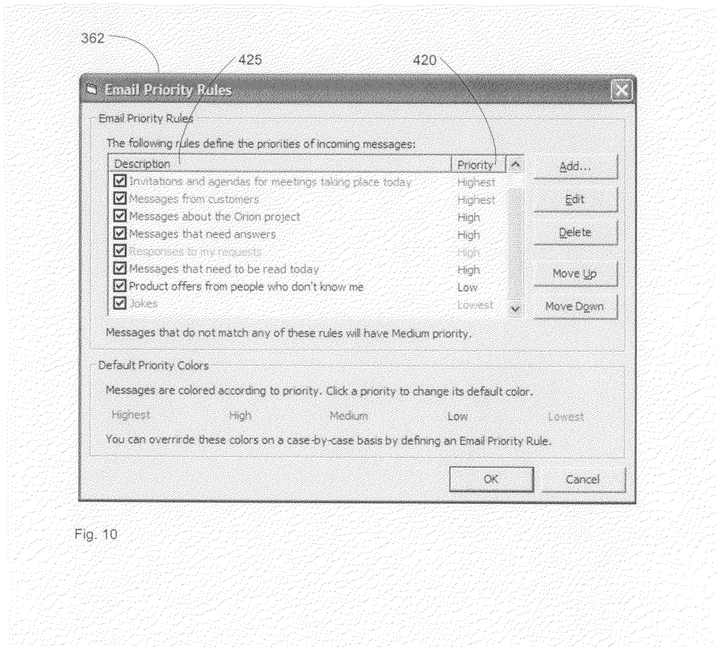

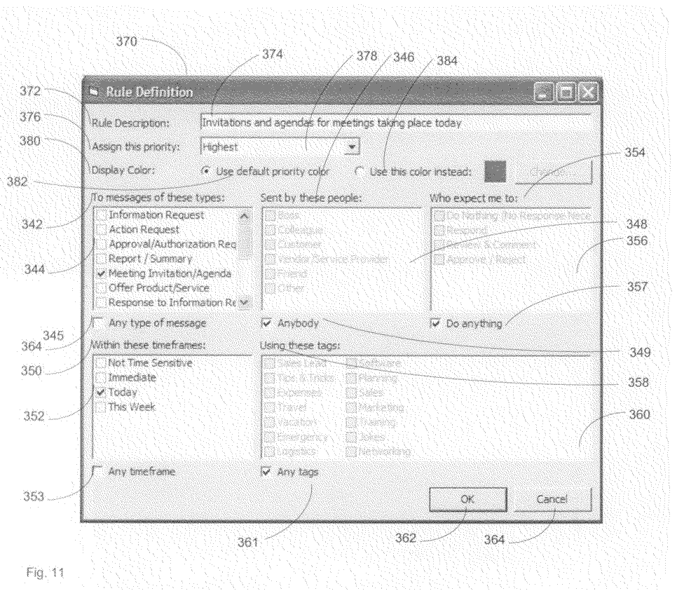

With further reference to FIG. 7 8 and 9, the sender 2: (a) composes an email message 300 (FIG. 8) and (b) clicks the Send button 310 on his Outlook interface 301. Before the e-mail message 300 is sent, (c) the PrioriTags add-in 110 displays a dialog 330 (FIG. 9) requesting that the sender 2 (d) categorizes the message 300 by (e) selecting tags from lists 360 previously published by the intended recipient 4 and stored in database 106 on server 107.

The sender at sender machine 102 selects suitable tags T from each multiple tag list 360 and (f) closes the dialog (FIG. 9) by clicking the OK button 362 causing the message 300 to be sent, with the selected tags T chosen by the sender 2 attached.

For example: Message Type 342: “Idea/Proposal 344”,

Sender Role 346 vis a vis recipient 4: Subordinate 348

Time Sensitivity 350: This Week 352

Expected Response 354: Review and Comment 356.

When the message 300 is received (h) by the recipient's 4 email program 216 the message 300 is analyzed by a rules engine 212, which identifies the relationship between sender and recipient, the message type, the expected response type and other properties by reading (h) tags T from the message 300, and assigns (i) a priority 420 to the message 300 by matching (0) message tags T to priority rules 420. The rules engine 212 uses rules 425 pre defined by the recipient 4, which map specific sets of tags T to corresponding priorities 420. It will be noted that the tags T used here may be published in such a way that the sender 2 could make use of them in other email messages.

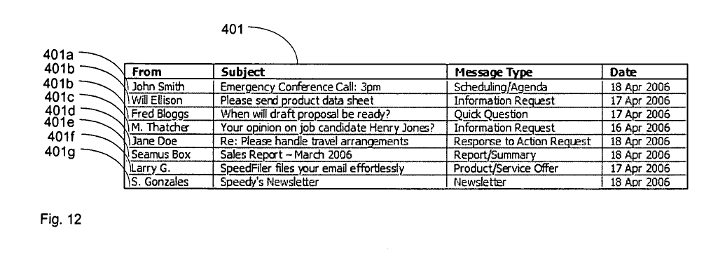

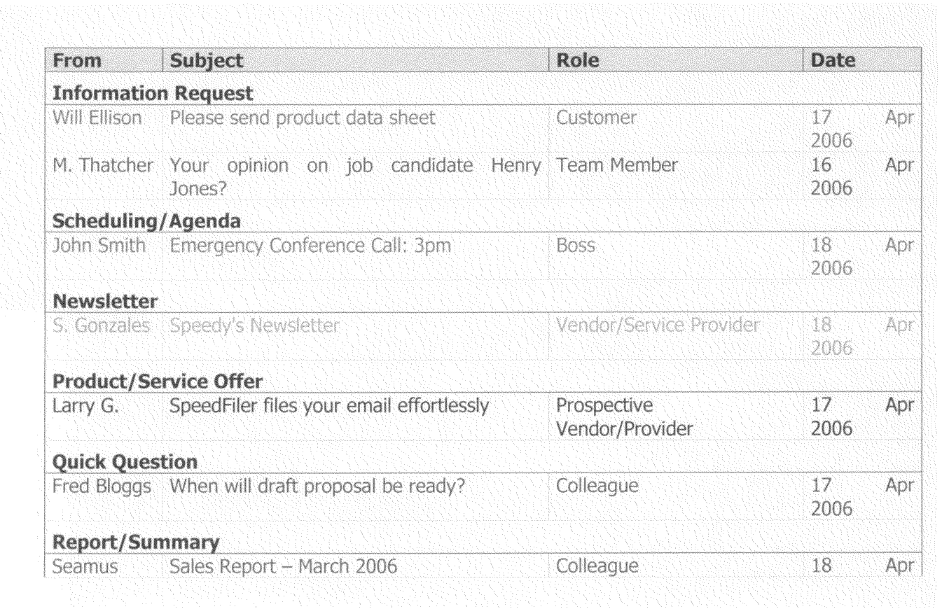

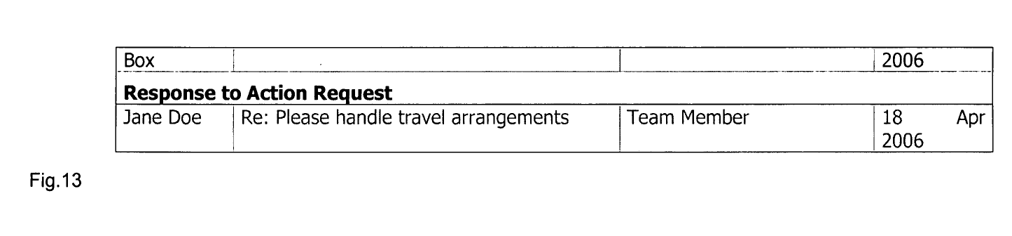

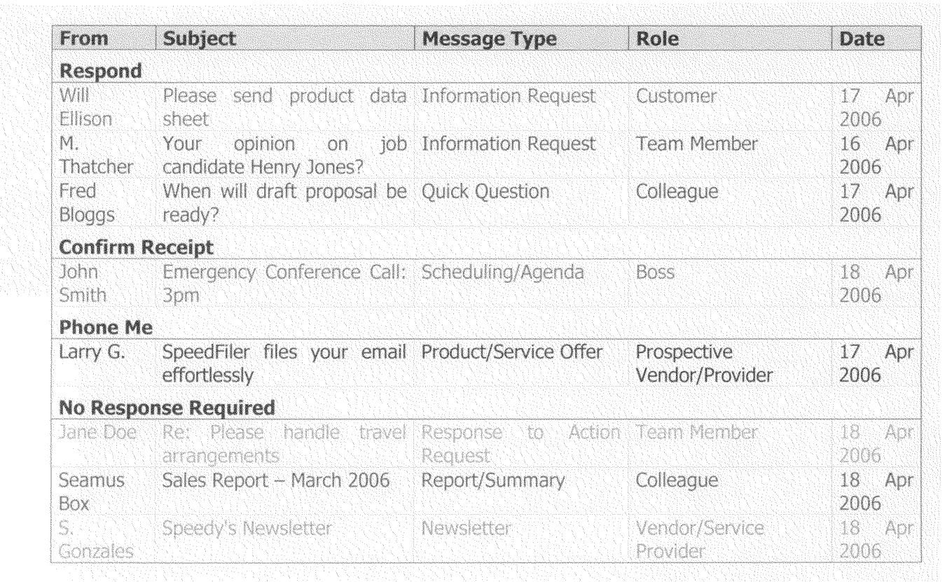

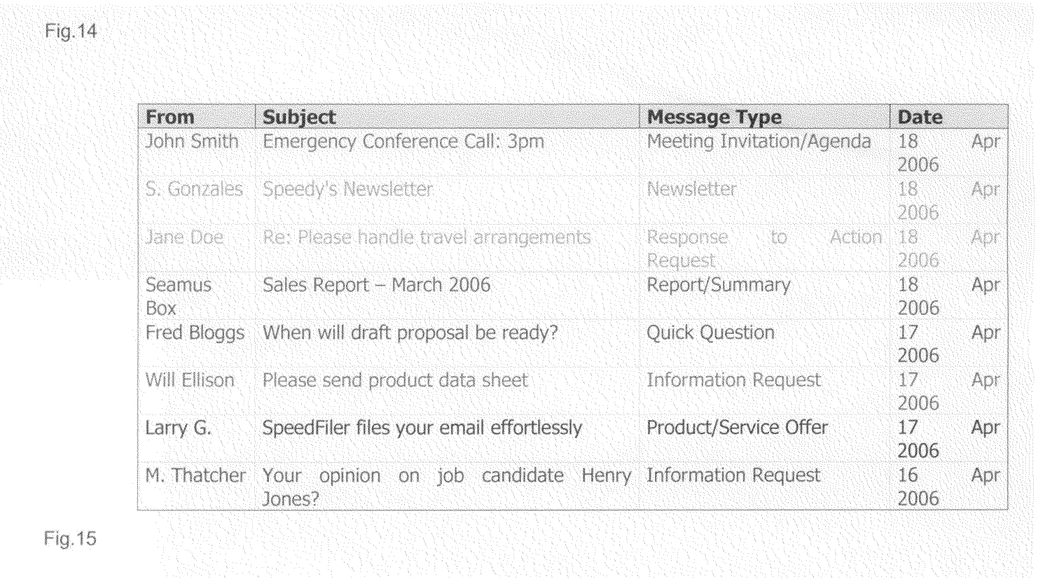

With further reference to FIG. 12, the recipient's email program 216 displays the arriving messages 401a, 401b, 401c, 401d . . . in order of priority 420 and/or grouped by message type 342, and the recipient 4 handles his email according to the priorities 420 and message types 342.

It will be appreciated that the sender 2 has a vested interest inoptimizing the message 1 so that it catches the attention of the recipient 4. It will further be noted that the sender 2 is familiar with the contents of the message 4 that is about to be sent. This makes it easy and useful for sender 2, to click a few extra buttons thereby characterizing the message 1. Although the sender 2 does not know what priority 420 the recipient 4 accords messages of the message type 344 having the selected tags T, 361, sender 2 can, nevertheless, be assured that it will be dealt with according to its true priority, and that it will be less likely to be missed due to an overflowing inbox or the like.

It will also be appreciated that the recipient 4 has an interest in implementing the PrioriTags add-in 210, since incoming mail 1 is pre-sorted and prioritized thereby in an automatic fashion.

Implementation of the PrioriTags system described hereinabove, harnesses the value of the community by allowing each sender 2 to be rated by the value they bring and by the integrity with which they tag T their outgoing messages 1. Recipients 4 will be able to ignore tags T on messages 1 from senders 2 who consistently attempt to misuse the system by tagging messages 1 with tags T1, T2, T3 . . . intended to give their message 1 an unwarranted high priority 420. Conversely, when receiving a message 1 from a sender 2 with whom the recipient 4 has no prior relationship, the recipient 4 will thereby have an indication from the community as a whole as to whether a specific sender 2 has brought value to others or whether this sender 2 is considered a nuisance. In this manner, spam is identified by sender identity not merely by content, and may be diverted to a Junk email folder, for example, not being displayed to the recipient at all.

The PrioriTags system has a number of useful features:

a) Sender 2 is prompted to enhance outgoing messages 1 with tags T chosen from a tag list 360 published by the recipient 4. This ensures that the sender 2 expresses clearly what response or action is requested, in terms that the recipient 4 can understand, and allows the message 1 to be automatically prioritized with a priority 420 by the email program 216 of the recipient 4. From the perspective of the sender 2, tagging an outgoing email 1 after requesting to send same, is somewhat similar to having a spell checker program being implemented automatically prior to the email being sent.

b) Incoming messages are automatically classified, prioritized 420 and sorted in accordance with sender 2 selected tags T.

c) The recipient 4 receives incoming messages 1 tagged up with tags T . . . offered by the recipient 4, and sorted and prioritized in accordance with prioritization rules 425 defined by the recipient 4.

d) In contrast with prior art email applications, information is made available by the recipient 4 to the sender 2 prior to the email 1 being sent. Consequently, messages such as “Out of Office” and the like are viewable by senders 2 before the email message 1 is sent.

The system of the present invention typically includes Client Software for installing by all users of the system, senders 2 and recipients 4 alike. Client Software helps the user define and publish their user profiles and prioritization rules. Client Software also color codes incoming messages and displays them in order of priority. When sending a message 1, Client Software prompts the sender 2 to select relevant tags T from a user profile 8 published by the recipient 4.

In selected embodiments, the system includes a Central Server 7, which is essentially a repository for all published user profiles 8. When a potential recipient 4 has defined the tags T that are relevant to the recipient 4, recipient's client publishes recipient user profile 8 to the Central Server 7. When a potential sender 2 wants to send recipient 4 a message, sender's Client downloads recipient's 4 user profile 8 from the Central Server 7, and sender selects tags from recipient's 4 user profile 8 that are relevant to the message 1.

Where a server 7 is used, the system will preferably be configured so that the client software does most of the work to minimize the processing performed by the server 7.

In one embodiment:

a) The client creates an encrypted user profile file 8 and uploads it to the central server, supplying the email address(es) for which it should be used. The upload is operated via a server-side script that places the file at the location determined by the primary email address, and places symbolic links to it, at locations corresponding to the other email addresses that were supplied.

b) No validation of the user profile file is required to be performed on the server since this can all be handled on the client side whenever the file is downloaded and interpreted. This conserves server resources that would otherwise be required for expensive operations such as encryption/decryption and XML validation.

c) In order to prevent subversion of existing user profiles by rogue users, and to prevent rogue users creating fake profiles for users who have as yet not signed up, operations will typically take effect only after a confirmation email is sent to the account holder's email address thereby reaching the real person, and not the rogue user. The account holder may confirm the action by clicking on a unique link in that email.

### EXAMPLE

Having provided an overview of the invention hereinabove, a preferred embodiment known as “Prioritags” is now described.

### Sending Messages

While editing an outgoing message or when the sender clicks Outlook's Send button, the sender is prompted with the Tag Outgoing Message window 330 (FIG. 9). If the recipient does not have an account, the sender will be prompted with an option to send him an invitation.

To avoid making the sender wait, it is useful to pre-fetch the recipients' user profiles, which include their tag lists and the like, in the background while the message is being edited.
The act of thinking about the content and selecting appropriate tags may cause the sender 2 to want to improve the subject line 334, so it may be presented here in editable form.
Each recipient has individual instructions and tag lists and thus gets dedicated individual tabs. In addition, the tab caption of the main recipient 336, John Smith, “TO:” may be distinguished from the “CC:” recipients Fred Bloggs and Jane Doe, since the expected reaction is different.
If a standard message type 342 is chosen for one of the recipients 336, it becomes the default choice for the other recipients for whom a message type 342 has not yet been selected. If a custom message type 342 is chosen, the default message type for the other recipients will be the closest standard message type (see Tag Properties: StandardID field)
The default expected reaction 354 for C.C.ed recipients is “Do Nothing” or “No Response Necessary”, but the defaults for all other values are typically set by default to be equivalent to any standard values chosen for a previous recipient.

It is a particular feature of the present invention that the instructions field 518 can be used for giving an “Out Of Office” message, or the like before the message is sent.

If a recipient has not opened an account, then the sender is presented with an option to send them an invitation to do so. The sender may also attach tags to the message, but only the standard tag lists will be available in such an instance. This is useful in instances where the recipient accepts the invitation to subscribe to the system of the invention as described herein, as it ensures that the e-mail message thus tagged will immediately be properly understood by the system.
If the sender is offline and a recipient's user profile has not been cached locally, it will be impossible to know whether a given recipient is subscribed to the service. In this case, only standard tag lists will be available, with the addition of an option to send an invitation, but the message at the top of the tab will be modified appropriately.
Where it takes time to obtain the recipient(s) user profile(s), the tab area may usefully be replaced with a progress graph while the sender waits. This situation is generally avoided however, since the recipients' information may be pre-downloaded and cached while the message is being composed.
By default, when replying to a tagged message, the Message Type 342 and Sender Role 344 values are reversed. This can be overridden by the user. For example:
   Message Type: Action Request
Response Message Type: Response to Action Request
   Sender Role: Subordinate
Response Sender Role: Boss

It will be noted that the response tags are standard tags, since these must be guaranteed to be available to both sender and recipient.
When replying to a message, the time sensitivity (if it is a standard value) should be preserved by default.
The sender must specify a value for every field except the Tags field.

### Defining Tag Lists and Tags

Each user profile contains standard tag lists. Users are unable to delete these lists or their pre-defined contents, but are able to add additional lists and add new tags to the predefined lists.

The User profile may be encrypted so that only PrioriTags can use it, and typically contains the following information:
Primary email address
Alternative email addresses
User's customized instructions for writing to him/her
Tag Lists

TABLE 1
Predefined Tag Lists

| Tag List Name | Tags | Comments |
|---|---|---|
| Message Type | Information Request | Sender chooses a |
| | Action Request | single value. |
| | Approval/Authorization | Response - |
| | Request | response to Other |
| | Quick question | or to a type that |
| | Information | does not have a |
| | Scheduling/Meeting | standard analogue |
| | Agenda | None - message |
| | Report/Summary | was not tagged |
| | Idea/Proposal | |
| | Newsletter | |
| | Product/Service Offer | |
| | Reminder | |
| | Response to Information | |
| | Request | |
| | Response to Action | |
| | Request | |
| | Response to | |
| | Approval/Authorization | |
| | Request | |
| | Response to Quick | |
| | question | |
| | Response to Information | |
| | Response to | |
| | Scheduling/Meeting | |
| | Agenda | |
| | Response to Report/ | |
| | Summary | |
| | Response to Idea/ | |
| | Proposal | |
| | Response to Newsletter | |
| | Response to | |
| | Product/Service Offer | |
| | Response to Reminder | |
| | Response | |
| | Other | |
| | None | |
| Expected | Do Nothing (No | Sender chooses a |
| Response | response necessary) | single value |
| | Respond | *Optionally maps |
| | Confirm Receipt* | to |
| | Phone me | Outlook/Exchange |
| | Review & Comment | receipt |
| | Respond when | mechanism. |
| | Complete | None - message |
| | Approve/Reject | was not tagged |
| | Other | |
| | None | |
| Time | Not Time Sensitive | Sender chooses a |
| Sensitivity | Immediate | single value. |
| | Today | *Optionally maps |
| | This Week | to standard |
| | Date*: (sender specifies) | Outlook flag date |
| | None | mechanism. |
| | | None - message |
| | | was not tagged |
| Sender Role | Boss | Sender chooses a |
| | Subordinate | single value. |
| | Colleague/Peer | None - message |
| | Company Employee | was not tagged |
| | Friend/Family | |
| | Customer | |
| | Vendor/Service Provider | |
| | Business Contact | |
| | Other | |
| | None | |
| Miscellaneous | (empty) | User will add tags |
| Tags | | to this category, |
| | | based on topics |
| | | that appear in |
| | | messages. |
| | | Sender may choose |
| | | any number of |
| | | these. |

### User-Defined Tag Lists

It will be noted that users can define tag lists that reflect their job function or industry practices. For instance, for the military or government, it would be possible to define a Classification list containing the tags: Top Secret, Secret, Restricted, Unclassified.

### Tag List Properties

TABLE 2
Tag list properties.

| Property | Type | Comment |
|---|---|---|
| ID | Text | Unique, short computer- |
| | | readable identifier for this |
| | | category |
| DisplayName | Text | Human-readable name for this |
| | | tag |
| IsUserDefined | Yes/No | Categories can be built-in or |
| | | user-defined |
| Instructions | Text | Text that instructs senders how |
| | | to choose tags from this |
| | | category |
| IsRequired | Yes/No | Whether sender must choose at |
| | | least one tag for this category |
| AllowMutliSelect | Yes/No | Yes: sender may select more |
| | | than one tag |
| AllowManualEntry | Yes/No | Yes: the sender may manually |
| | | enter a tag code (See example |
| | | in 7.1.4.5.b and 7.1.4.6.b) |
| Tags | List | List of tags that belong to this |
| | | list |
| ID | Text | Unique, short computer- |
| | | readable identifier for this tag |
| DisplayName | Text | Human-readable name for this |
| | | tag |
| Instructions | Text | Text that tells senders what this |
| | | tag means to the recipient, and |
| | | when to use it |
| IsUserDefined | Yes/No | Tags can be built-in or user- |
| | | defined |
| IsDefault | Yes/No | Yes: this tag should be selected |
| | | by default, when the sender is |
| | | presented with choices |
| IsHidden | Yes/No | Yes: this tag should not be |
| | | shown to senders |
| StandardID | Text | For user-defined tags in |
| | | standard tag lists: the ID of the |
| | | standard tag that is closest in |
| | | meaning. This is used to set an |
| | | appropriate default for a future |
| | | reply, by retrieving the |
| | | standard tag's ReciprocalID. |
| RecprocalID | Text | For standard tags: ID of a |
| | | standard tag to use when |
| | | replying to a message |
| | | containing the current tag, e.g. |
| | | Boss ←→ Subordinate |

### User Interface for Defining Tag Lists

Maintenance of Tag Lists may be achieved by a user maintained list of tag types, such as Message Type, Original Type, Expected Response, Time Sensitivity, Sender Role, Miscellaneous, and the like, via a user displayable Tag List dialog box.

The user is able to interact with the lists by Adding, Deleting and Editing them, for example. Once finished, the user can accept or reject the changes, via selection of OK or Cancel buttons in the usual way.

Choosing to Add or Edit a tag list could invoke a Tag List Settings dialogue, in which the tags belonging to a specific list can be configured.

The identifier field of a tag list must be validated as uniquely identifying a tag list. It is used to provide a machine-readable representation of the tag lists and corresponding tags for a given message, for example: SECCLASS=TOPSECRET

For standard tag lists, none of the settings should be editable, but the user may add additional tags, and (re)define the default tag.

“Allow manual entry of hidden tags” allows use of secret tags known to both sender and recipient. For example, a user may want to give selected close associates a special tag which gives their messages the highest priority. To ensure that only his close associates can use the tag, he marks it as “Hidden” and allows manual entry of hidden tags.

If a tag is not appropriate for the current user, it can be hidden. Senders will not be able to select hidden tag. If the user wishes to give certain people a secret priority code, the tag should not be shown to senders, but the option to allow them to enter it manually should be checked in the Tag List Settings dialog. This will cause a text field to be provided to allow them to enter the appropriate tag (the secret priority code). For standard tags, all fields should be locked.

### Defining Priorities

Ways for a sender 2 to tag an outgoing message 1 with tags T have been described hereinabove. The recipient 4 may use the tags T to prioritize incoming messages.

Based on the tags attached to incoming messages, a recipient 4 can define a priority to each incoming message such as lowest, low, medium, high, highest, and the like.

Priorities can be used to sort messages as displayed in the inbox.

In addition, each message may be color-coded according to the priority assigned to it.

In order to assign a priority to messages that match a given set of criteria, it is necessary to define Priority Rules. Each user will typically have a number of these rules.

The order of the various rules in the priority list dictates the order in which messages will be compared to rules.

The individual rules in the list may be color coordinated, with the colors assigned, being used to display the messages in the inbox. Changing the default color of a priority causes the rule list to be refreshed, reflecting the new choice.

It will be noted that the “Responses to my requests” rule overrides the default color for High Priority messages.

As messages arrive in the Inbox folder, they are evaluated according to the rules and assigned priorities. The tags attached to each message are compared with each rule in the order defined by the user. The first rule that matches the tags, defines the priority and color of the message. A message that does not match any rules is typically assigned a Medium Priority, and the corresponding color.

PrioriTags offers a number of ways to view email.

With reference to FIG. 12, for example, the “PrioriTags Priority View” displays messages in descending order of priority, with each message color-coded according to its priority. This helps the user to process the messages in order of importance.

Within a given priority band (e.g. “Highest”), the position of an item is determined by the Priority Rule that matches it. The higher up the rule in the rules list, the higher up matching items are displayed.

With reference to FIG. 13, a “Message Type View” displays messages grouped according to their Message Types, and color coded according to their priorities. This view helps the user handle all messages of a particular type. Within each Message Type section, the order is descending priority.

With reference to FIG. 14, an “Expected Response View” displays messages grouped according to the type of response that is expected. This view helps the user to focus on messages that require responses.

With reference to FIG. 15, a “Traditional View” sorts incoming mail by reverse order of arrival, color-coded by message type and/or rule color definition. This view is similar to the “traditional” arrangement of prior art email programs, except that the messages are color-coded according to importance.

By way of providing enablement only, in one embodiment, a method for Attaching and Reading Tags to/from Messages utilizes a feature of Microsoft Outlook known as Categories, which is a convenient general-purpose mechanism for tagging messages and other items. Each item in Outlook has a Categories field, which accepts free-text values, separated by commas. If Categories are assigned to an outgoing message, it will arrive at its destination with the categories intact, whether the protocol used to transmit the message is Microsoft's Exchange protocol or standard SMTP. Outlook maps the contents of the Categories field to the RFC 822 Keywords header field. The present invention may utilize the category feature of Microsoft Outlook to retroengineer Outlook to support Prioritags.

Having drafted a message, when the sender clicks the Send button in his e-mail interface, the Tag Outgoing Message window is displayed. The tags shown in this window are the result of downloading and parsing the profiles of the recipients. Once the sender has selected the relevant tags for each recipient, the tags need to be attached to the outgoing message. This may be done by encoding the tags into a string, which is then assigned to the Categories property of the Outlook message.

The tags that are relevant to each recipient should be represented by a single string that conforms to the following format, so that each recipient can identify the tags relevant to him:

ptag://<RECIPIENT ADDRESS>?<ID OF TAG
LIST1>=<ID OF TAG1>&<ID OF TAG LIST2>=<ID OF
TAG2> ... &<ID OF TAG LISTN>=<ID OF TAGN>

### This format is similar to the format of a HTTP URL, and employs similar rules to govern encoding of extended characters.

For example, consider a message sent to user@company.com and someone@somewhere.com, that has the following properties:

| Tag List | user@company.com | someone@somewhere.com |
|---|---|---|
| Message | Action Request (actionreq) | |
| Type | | |
| Expected | Respond When | No Response Required |
| Response | Complete (rwc) | (nrr) |
| Time | Immediate (immdt) | |
| Sensitivity | | |
| Sender Role | Boss (boss) | Colleague (coll) |
| Miscellaneous | Sales, Marketing, | Budget |
| Tags | Finance | |

The above tags might be encoded as follows:

ptag://*?msgtype=actionreq&time=immdt,
ptag://user@company.com?expresp=rwc&sndrole=boss&
tags=sales&tags=marketing&tags=finance,
ptag://someone@somewhere.com?expresp=nrr&sndrole=
coll&tags=budget

When an incoming message is received by the recipient email program, incoming message is processed according to the prioritization rules by reading its tags. A given message may contain tags for a number of different users, but each recipient needs only the tags that are relevant to him.

In order to extract the relevant tags (if any) for a specific recipient (e.g. user@company.com):

The Categories field (Keywords SMTP header) may contain comma-delimited values. Each of these should be examined in turn.

The value that starts with ptag://user@company.com/ will contain the tags that are applicable to this recipient. Note: there may not be such a value.

Once the relevant value has been identified, the pairs of parameters that occur after the ? symbol should be parsed. Each pair is delimited by an & symbol and takes the format taglist_id=tag_id, where taglist_id identifies a tag list, and tag_id identifies the individual tag that was chosen by the sender from this list.

After the ID's have been separated, they should be un-URL encoded in order to reflect any special characters that they use.

Sometimes, newsletters and the like are treated as junk mail or spam by spam filters that look for various message characteristics and erroneously assume spamming. In certain embodiments the tagging system of the present invention may be configured appropriately and used to bypass or to disenable Anti-Spam features, on a per-message basis. One way of achieving this is now presented: If an intended recipient subscribes to a newsletter and wishes to receive that newsletter, the recipient may provide a special tag that is then used by the sender to tag the newsletter as NOT SPAM. The spam filter is then set to always allow messages tagged with the NOT SPAM tag. Such a tag may be a general purpose recipient tag of the recipient used as a general NOT SPAM filter tag for bypassing spam filters. All messages tagged with the general purpose recipient NOT SPAM tagged are allowed through the spam filter. Alternatively, for added security, special individual sender dedicated tags may be generated for each and every sender, with the special individual sender dedicated tag being provided with a rule to allow passage through the Spam filter. In this manner, if the recipient decides that the sender has passed on the sender dedicated tag to someone else or otherwise is unhappy with the email messages tagged by the special individual sender dedicated tag, the recipient may reconfigure the spam filter to treat all messages tagged with the tag as junk. Furthermore, it will be noted that special individual sender dedicated tags may be encrypted using symmetrical or asymmetrical encryption keys for added security.

In some embodiments, particularly those designed for internal use within a company, or an intranet, Aristotelian logic and the like, may be used to make inferences about relationships between a sender and a new recipient from knowledge of relationships between the sender, recipient and a third party. Thus if, A is B's superior, and B is C's superior, A is C's superior.

Some relationships are associative in this way, and others are not, e.g. If A is B's customer and C is B's customer, it says nothing about the relationship between A and C. In general, relationships that are commutative (both sides of the relationship define each other the same way: A is B's peer=>B is A's peer) can be used to infer such relationships.

In some cases of non-commutative (reciprocal-type) relationships, e.g. Vendor/Customer, if A is B's customer, and C works with B (as a peer, company employee etc.), then A is at least likely to be C's customer, and can be set as a default, perhaps.

This is useful because in such embodiments, the system can infer how the sender is related to a recipient, even if the recipient has not explicitly defined the relationship yet. The system could make the inference based on relationship information stored on the central server or even by examining other messages in the inbox to see how they are tagged, thus if A sent B a message, with C as a C.C.ed recipient, through seeing how A defined the relationship between A and B, C may be able to infer his relationship with A and/or B in many cases.

It will be appreciated however, that the present invention may be programmed in other ways, and that most of the details provided hereinabove are provided by way of enablement only, and are optional features.

Thus the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. A method of improved handling of an email by a recipient email program comprising the steps of:
(a) displaying a dialog to a sender of the email in response to the sender attempting to send the email to the recipient, wherein the dialog allows the sender to select tags for tagging the email, said tags being predetermined by the recipient;
(b) sending the email together with tags selected by the sender from list of tags offered by the recipient, and
(c) using the selected tags to prioritize the incoming email in accordance with recipient categories.

2. The method of claim 1 wherein said tags comprise tags for classifying relationship between the sender and the recipient.

3. The method of claim 2, the relationship being selected from the list of: boss, subordinate, colleague/peer, company employee, friend/family, customer, vendor/service provider, business contact.

4. The method of claim 1, wherein the tags comprise tags for identifying subject matter of the email.

5. The method of claim 1 wherein predetermined tags include a generic description of type of email selectable from a plurality of generic descriptions including at least some of: Action Request, Approval/Authorization Request, Quick Question, Information, Scheduling/Meeting Agenda, Report/Summary, Idea/Proposal, Newsletter, Product/Service Offer, Reminder, Response to Information Request, Response to Action Request, Response to Approval/Authorization Request, Response to Quick Question, Response to Information, Response to Scheduling/Meeting Agenda, Response to Report/Summary, Response to Idea/Proposal, Response to Newsletter, Response to Product/Service Offer, Response to Reminder, Response and Other.

6. The method of claim 1 wherein the tags are selectable from default lists provided with a program that incorporates the method of handling emails of the invention.

7. The method of claim 1 wherein the tags are recipient defined.

8. The method of claim 1 wherein the recipient can offer a range of acceptable times for preferred response for the sender to tag the email so that the recipient is notified how urgent the response is to the sender.

9. The method of claim 1 for bypassing spam filters, wherein the email is a message or newsletter of interest to recipient and the tag is a spam filter bypass tag of the recipient and the method further comprises configuring spam filters to always allow messages tagged with the spam filter bypass tag to bypass spam filters and to reach an inbox of the recipient's email program.

10. The method of claim 9 wherein the spam filter bypass tag is a dedicated tag provided by the recipient to a specific sender only and configured to only allow messages originating from the specific sender to reach the inbox of the recipient.

11. The method of claim 1 wherein an email sent to a plurality of recipients in a recipient list will be tagged by the sender system individually for each recipient in accordance with said recipient specific tags.

12. The method of claim 1, the recipient tags being published on a server.

13. The method of claim 1, the recipient tags being previously sent to sender in a previous email exchange.

14. A software package for installing on an email terminal comprising tools for enabling a user to define and publish user profiles for displaying to an email sender.

15. The software package of claim 14 for color coding incoming messages and for displaying incoming messages in accordance with rules predefined by the recipient.

16. The software package of claim 14 comprising prioritization rules for selection by the user to aid processing of incoming emails.

17. The software package of claim 14 for prompting the user to select relevant tags from user profiles published by the intended recipient when sending an email to the intended recipient.

18. The software package of claim 14 wherein the user can select and offer the sender a range of responses acceptable to the user.

19. The software package of claim 14 wherein an email sent to multiple recipients may be tagged differently for each recipient.

20. The software package of claim 14 wherein a main recipient of an email as identified by a TO field will be flagged with different tags from additional recipients as identified by C.C. and B.C.C. fields.
